(19) United States
(12) Patent Application Publication
(10) Pub. No.: US 2013/0292403 A1
(43) Pub. Date: Nov. 7, 2013

(54) Pill Container

(71) Applicants: Joseph Cote, New York, NY (US); Minhao Shi, New York, NY (US)

(72) Inventors: Joseph Cote, New York, NY (US); Minhao Shi, New York, NY (US)

(73) Assignee: CapsulePen LLC, Brooklyn, NY (US)

(21) Appl. No.: 13/462,274

(22) Filed: May 2, 2012

(51) Int. Cl. B65D 83/04; A61J 1/03; B23P 17/00; B65G 59/02

(52) U.S. Cl. 221/92; 221/282; 221/279; 221/199; 206/534.1; 29/592

(57) ABSTRACT

Among other things, we describe an apparatus that includes a tubular body elongated along a longitudinal axis and having an interior cavity and a first open end, the interior cavity extending along the longitudinal axis and sized to receive multiple pharmaceutical pills, the interior cavity having a largest cross-sectional dimension perpendicular to the longitudinal axis that is sized to fit a single pharmaceutical pill within the cavity, the first open end sized to admit a pharmaceutical pill into the interior cavity, and a device to selectively allow insertion and removal of pills from the interior cavity.

### TECHNICAL FIELD

This description relates to a pill container.

### BACKGROUND

Pharmaceutical pills, for example, often come in short round plastic bottles with childproof lids. Sometimes people move them into other kinds of containers that are set up to make it easier to take the pills as prescribed during a day or a week.

### SUMMARY

In general, in one aspect, an apparatus includes a tubular body elongated along a longitudinal axis and having an interior cavity and a first open end, the interior cavity extending along the longitudinal axis and sized to receive multiple pharmaceutical pills, the interior cavity having a largest cross-sectional dimension perpendicular to the longitudinal axis that is sized to fit a single pharmaceutical pill within the cavity, the first open end sized to admit a pharmaceutical pill into the interior cavity, and a device to selectively allow insertion and removal of pills from the interior cavity.

Implementations can include one or more of the following features. The device may include a cap to cover the first open end. The tubular body may have a length greater than a sum of the lengths of longest sides of a maximum number of pharmaceutical pills accommodated by the tubular body. The tubular body may have a polygonal cross-section. The polygonal cross-section may be a hexagonal cross section. The device may have a polygonal shape corresponding to a shape of the polygonal cross-section. The tubular body may have a length of at least five times greater than a width of the tubular body. The device may be affixed to the tubular body by a hinge. The device may include a magnet. The apparatus may include a mechanism that pushes pills through the first open end. The apparatus may include a sliding mechanism housed within the tubular body and operable to push pharmaceutical pills through the first open end. The apparatus may include a spring housed within the tubular body and configured to push pharmaceutical pills through the first open end.

The tubular body may include a first tubular piece sized to receive a second tubular piece. The first tubular piece may be sized to slidably receive a second tubular piece. The first tubular piece may include threading sized to receive threading of the second tubular piece. The second tubular piece may include a cutout sized to admit at least one pill into a chamber within the second tubular piece. The tubular body may have a length approximately equal to a length of a writing instrument. The apparatus may include a divider housed within the tubular body, in which two spaces formed by the tubular body and the divider are sized to house at least one pharmaceutical pill.

The device may include a push button. The push button may be configured to open a door covering a second open end of the tubular body. The device may include a sectional door. The sectional door may include sections which open responsive to pressure. Each section may include a spring hinge. The apparatus may include a writing tip.

In another aspect, in general, an apparatus includes seven pill containers arranged in a hexagonal formation, each pill container including a tubular body elongated along a longitudinal axis and having an interior cavity and a first open end, the interior cavity extending along the longitudinal axis and sized to receive multiple pharmaceutical pills, the interior cavity having a largest cross-sectional dimension perpendicular to the longitudinal axis this is sized to fit a single pharmaceutical pill within the cavity, the first open end sized to admit a pharmaceutical pill into the interior cavity, and a device to selectively allow insertion and removal of pills from the interior cavity, in which at least part of a magnetic portion of each pill container is in contact with a portion of another one of the pill containers.

Implementations can include one or more of the following features. The device of each pill container may include the magnetic portion. The body of each pill container may include the magnetic portion. The pill containers may each have a hexagonal shape, and a face of each pill container is in contact with a face of one of the other pill containers.

In another aspect, in general, an apparatus includes a holder for a chain of elongated pharmaceutical pills arranged in a row in an oblong chamber, in which a largest cross-sectional dimension of the chamber is smaller than an elongated dimension of any of the elongated pharmaceutical pills.

In another aspect, in general, a method includes manufacturing pill containers, each pill container including a tubular body elongated along a longitudinal axis and having an interior cavity and a first open end, the interior cavity extending along the longitudinal axis and sized to receive multiple pharmaceutical pills, the interior cavity having a largest cross-sectional dimension perpendicular to the longitudinal axis that is sized to fit a single pharmaceutical pill within the cavity, the first open end sized to admit a pharmaceutical pill into the interior cavity, and a device to selectively allow insertion and removal of pills from the interior cavity, in which at least one pill container has a width different from a width of another pill container.

Other features and advantages will become apparent from the following description, and from the claims.

### DESCRIPTION OF DRAWINGS

FIG. 1 shows a pill container.

FIG. 2 shows a pill container carried by a human being.

FIGS. 3A and 3B are side and perspective views of a pill container.

FIG. 4 shows a cap for a pill container.

FIGS. 5A, 5B, and 5C are side, top, and front views of a pill container.

FIG. 6 shows a bundle of pill containers.

FIGS. 7-10B and 12A-17 show other kinds of pill containers.

FIGS. 11A-11B show a sectional door.

### DETAILED DESCRIPTION

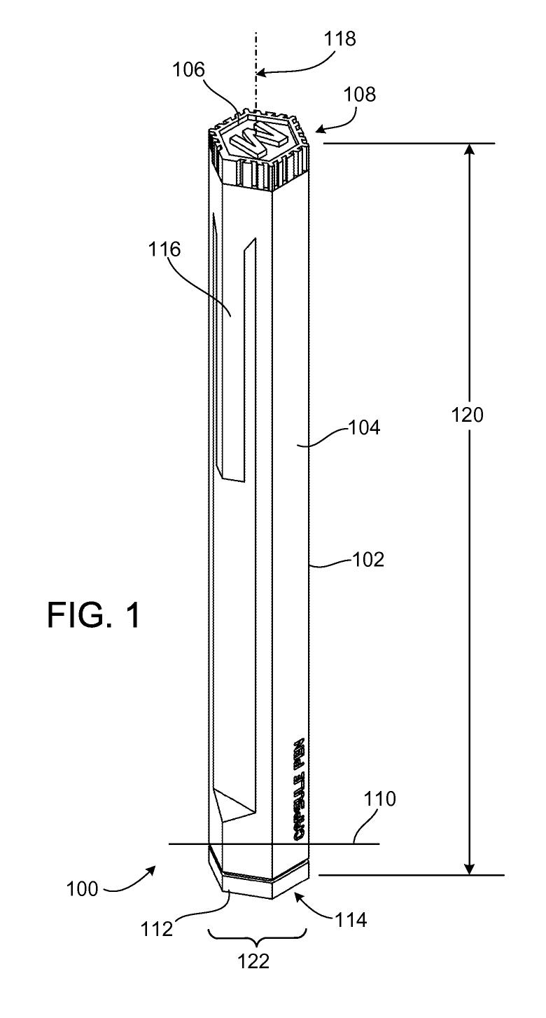

FIG. 1 shows a pill container 100 having an elongated, tubular body 102 to hold pharmaceutical pills. The shape of the pill container 100 is chosen so that it is convenient for a human being to carry the pill container 100 and access the pills inside.

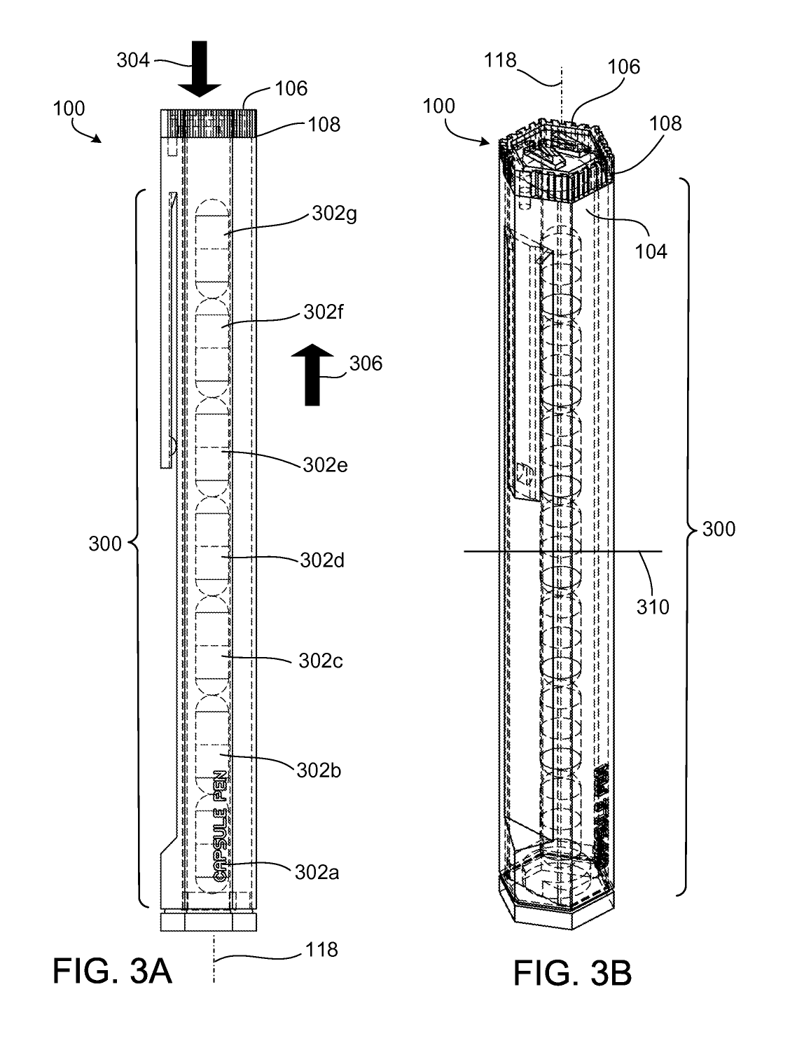

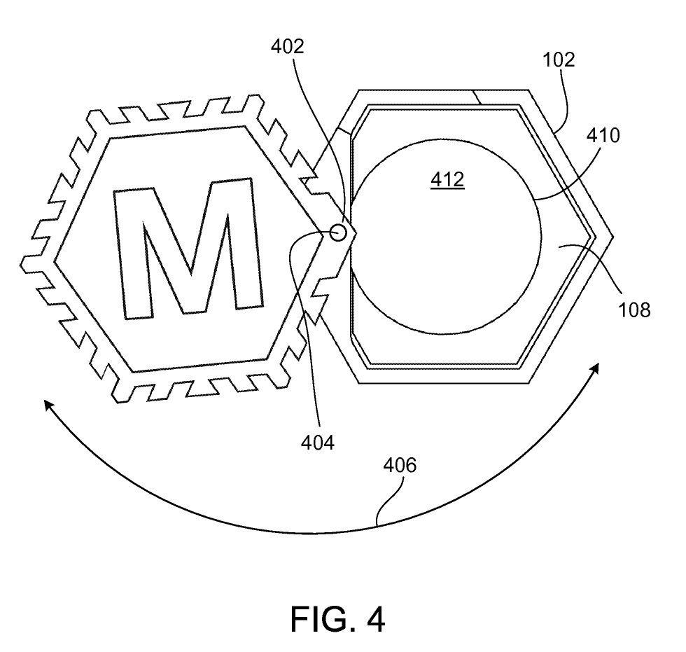

The tubular body 102 has an interior cavity 104 (hidden in FIG. 1 but visible in FIGS. 3A, 3B, and 4) that can hold multiple pills lined up in a row. A cap 106 covers one end 108 of the tubular body 102 and can be opened (e.g., removed, slid off, flipped open, or popped off, among other things) to remove pills from the interior cavity 104 and admit pills into the interior cavity 104. Here, the tubular body 102 has a cross-section 110 in the shape of a hexagon. Other versions of the pill container 100 could have a different shape to the cross-section 110. For example, the cross-section 110 could have the shape of another kind of polygon, or could have a round shape, or could have another kind of shape. In some implementations, the interior cavity 104 has a shape similar to a shape of the tubular body 102. For example, if the tubular body 102 has a hexagonal shape (e.g., a hexagonal cross-section), the interior cavity 104 may also have a hexagonal shape. In some implementations, the interior cavity 104 has a shape different from a shape of the tubular body 102. For example, if the tubular body 102 has a hexagonal shape, the interior cavity 104 may could have a different shape such as a cylindrical shape (e.g., having a circular or oval cross-section).

When pills are admitted into the interior cavity 104 the pills will accumulate in the cavity in a row because the cross-section 110 of the tubular body 102 causes the cross-section of the interior cavity 104 is large enough to fit at most a single pill rather than multiple pills. A cross-section of the interior cavity 104 is shown in FIGS. 3A, 3B, and 4. Put another way, the pill container 100 is generally wide enough only to accommodate a single pill at any point along a longitudinal axis 118 of the pill container 100. Pills may come in a variety of shapes and sizes, and so in some examples, some pills may overlap within a cross-section 110 at certain points along the longitudinal axis 118. For example, a pill having a rounded edge may contact another pill having a rounded edge in a way that causes the very ends of the rounded edges to minimally overlap. However, the shape of the interior cavity 104 is chosen to minimize overlap of pills within any cross-section 110 of the tubular body 102. Further, the tubular body 102 has a length 120 that is at least, or greater than, a sum of the lengths of the longest sides of the maximum number of pharmaceutical pills accommodated by the tubular body 102 (e.g., accommodated by the interior cavity 104).

When we refer to pills or pharmaceutical pills, we mean any kind of capsule, tablet, or other pill that is ingested by a human being. The pills could be prescription pills, or off-the-shelf medication like NSAIDs or painkillers, or nutritional supplements such as vitamins or antioxidants, or any other kind of substance. Most pills contain a substance documented in a standard reference for these kinds of substances. The reference work is sometimes called a pharmacopoeia and may be maintained by a governing body of a country, an administrative agency, or a non-profit organization.

Pills in the shape of capsules usually have an elongated body and rounded edges. One example of a capsule having an elongated shape is shown in FIGS. 3A and 3B. Most capsules have a length of between ten and twenty millimeters, but some are slightly smaller or larger. Most capsules also have a diameter of between five and ten millimeters. Capsules can conform to standard sizes which sometimes have numerical designations such as “3,” “2,” “1,” “0,” “00,” and so on. For example, a “0” sized capsule may have a standard length and diameter which is larger than the length and diameter of a “1” sized capsule. Among other things, a capsule having a standard size can contain a consistent dose of a pharmaceutical or nutritional supplement. A pill container 100 could be designed to hold a pill of a particular standard size. Further, one pill container could be produced to hold one size of pill (e.g., one capsule of a standard size), and another pill container could be produced to hold another size of pill. A single pill container could also contain pills of multiple types and having similar, but not identical, sizes.

Pills can come in other forms besides capsules. Some pills are called tablets, and sometimes have a round shape or oval shape rather than an elongated shape. The diameter of a tablet is usually larger than the diameter of a capsule. Also, some tablets are called softgels, especially tablets with a gelatin coating or encapsulating material. A pill container could even store other kinds of objects that have approximately the same size and shape as a pill.

The tubular body 102 could be made of a substantially transparent material, or a substantially opaque material, or a substantially translucent material, or portions of the tubular body 102 could be made of any or all of these. Some materials that could be used include a metal material, a plastic material, a wood material, a glass material, fiberglass, stone, rubber, clay, porcelain, bamboo, paper, cardboard, or other natural or synthetic materials, including original materials or recycled materials, disposable materials, or any combination of these. The cap 106 and other components of the pill container 100 could also be made of any of these materials.

In some implementations, the pill container 100 has a second cap 112 that covers a second end 114 of the tubular body 102. The second cap 112 can be opened to remove pills from the interior cavity 104 and admit pills into the interior cavity 104. If the first cap 106 cannot be opened (e.g., if the cap 106 is jammed or stuck) then the second cap 112 can be opened and the second end 114 can be used as an alternative to the first end 108 as a point of access to the interior cavity 104.

In some implementations, the pill container 100 has a clip 116 attached to or integrated with the tubular body 102. The clip 116 allows the pill container 100 to be affixed to an item of clothing. In some examples, the clip 116 can be attached to or integrated with the cap 106 or the second cap 112. The clip 116 could be made of the same material as the tubular body 102 or could be made of a different material.

In some implementations, some or all of the components of the pill container 100 are magnetized, e.g., made of a magnetic material or made at least partially of a magnetic material. For example, the cap 106 or the second cap 112 or the tubular body 102 or the clip 116 could be magnetized. If at least one of the components of the pill container 100 are magnetized then the pill container 100 could be affixed to some metal surfaces such as a refrigerator door.

Pills may be admitted into the interior cavity 104 by a human being who manually opens the cap 106 and inserts pills into the interior cavity 104, or pills may be admitted into the interior cavity 104 by a machine that inserts pills into the interior cavity 104, or pills may be admitted into the interior cavity 104 using another technique.

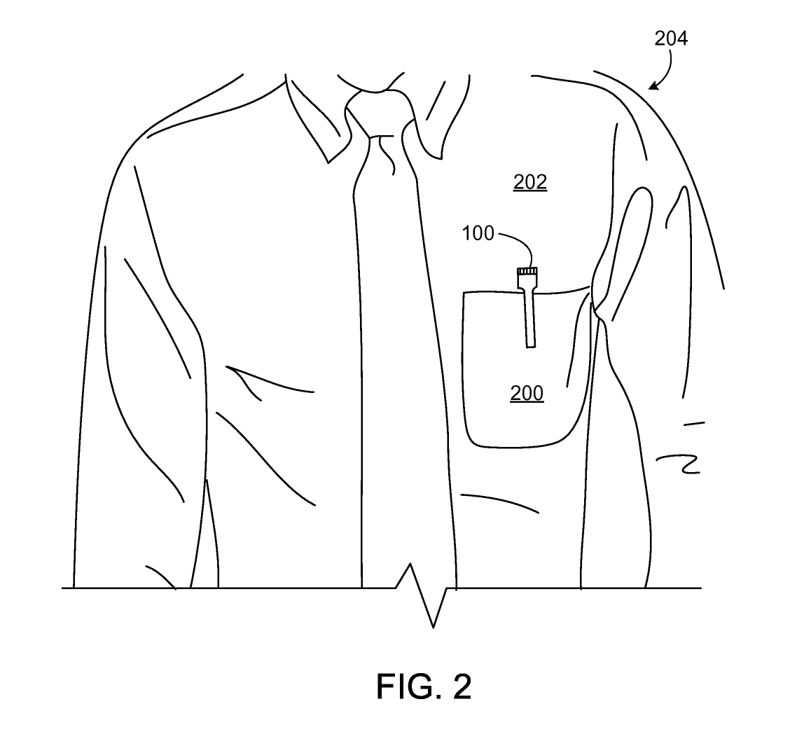

FIG. 2 shows the pill container 100 in a shirt pocket 200 of a shirt 202 worn by a person 204. The elongated shape of the pill container 100 gives the container similar dimensions to a pen or other writing instrument. The pill container 100 can be placed in any receptacle, pouch, pocket, or other vessel into which writing instruments can be placed. As shown in FIG. 2, the pill container 100 appears to be a writing instrument when placed in the shirt pocket 200. Because many vessels for writing instruments exist in clothing, briefcases, backpacks, desk drawers, and other types of apparel or luggage, the pill container 100 can fit into many of those existing vessels. A person 204 can thus make use of those existing vessels when carrying his or her pill container 100. This may make the person 204 more likely to carry the pill container 100 rather than, for example, forget to bring the pill container 100 or find the pill container 100 inconvenient to carry. Further, the person 204 may prefer that the pill container 100 appear to be a writing instrument so that no attention is called to the pill container 100.

Writing instruments come in a variety of shapes and sizes and so the pill container 100 could be designed to have any of these shapes and sizes and achieve the goal of mimicking a writing instrument. For example, writing instruments are commonly at least five times as long as they are wide. Accordingly, the pill container 100 can be designed to be at least five times as long as it is wide. A longer pill container 100 can accommodate more pills, because the pill container 100 is generally wide enough only to accommodate a single pill at any point along the longitudinal axis of the pill container 100. Further, different versions of the pill container 100 can have different widths 122. Pill containers 100 having one width 122 can accommodate pills having one width, while pill containers 100 having another width 122 can accommodate pills having a different width.

FIGS. 3A and 3B show a row 300 of pills 302a-g within the interior cavity 104 of the tubular body 102 of the pill container 100. A cross-section 310 of the interior cavity 104 intersects, at most, one pill 302a-g. Seven pills 302a-g are shown in the figure, and no more than seven pills 302a-g will fit within the interior cavity 104 of this pill container 100. Other versions of the pill container 100 could fit a greater or lesser number of pills within their respective interior cavities, for example, depending on the degree to which the interior cavity 104 is elongated along the longitudinal axis 118 of the pill container 100. Because the pills 302a-g are arranged in a row 300, the pills will retain the order in which they were inserted into the pill container 100 even if the pill container 100 is transported, shaken, or disturbed.

If the interior cavity 104 of the pill container 100 is empty, a first pill 302a can be inserted 304 into the open end 108 of the tubular body 102. If the pill container 100 is held in an upright orientation 306 or a substantially upright orientation then the first pill 302a will slide toward the second open end 114 of the interior cavity 104. The first pill 302a is held inside the interior cavity 104 by the second cap 112. If the orientation of the pill container 100 changes, the first pill 302a may slide from the second open end 114 back to the first open end 108 or anywhere in between.

If a second pill 302b is inserted 304 into the open end 108, the second pill 302b will enter the interior cavity 104 at a position ahead of the first pill 302a. Depending on the orientation of the pill container 100, the second pill 302b may slide to contact the first pill 302a and rest in position in contact with the first pill 302a. The second pill 302b may freely slide between the first pill 302a and the cap 106. However, the second pill 302b will not pass beyond the first pill 302a within the interior cavity 104 because the cross section 310 of the interior cavity 104 is not large enough to admit two pills. If a human being in possession of the pill container 100 wishes to remove the first pill 302a at the open end 108 then he or she must first remove the second pill 302b. If a third pill 302c is inserted, the third pill 302c would have to be removed before the second pill 302b is removed.

In this way, pills 302a-g inserted into the pill container 100 will remain in the order in which they have been inserted. The pill 302a-g most recently inserted into the open end 108 of the pill container 100 is also the first pill that can be removed from the pill container 100. This configuration is sometimes called “last in, first out” or “LIFO.” As an example of use, a human being could insert a pill to be taken in the evening of the subsequent day prior to a pill to be taken in the morning of the subsequent day. On the subsequent day, when the human being opens the cap 106 to take one pill, the pill to be taken in the morning will be the first pill capable of exiting the interior cavity 104 at the open end 108. The pills 302a-g could be of multiple types and placed in the pill container 100 in an order that conforms to an order in which a human being is to take the pills 302a-g.

FIG. 4 shows the cap 106 of the pill container 100. The cap 106 covers an open end 108 of the tubular body 102. The open end 108 is a point of access to an interior cavity 412. This version of the interior cavity 412 has a circular cross section 410. Thus, this version of the interior cavity 412 has a cylindrical shape.

The cap 106 is an example of a device that can be used to selectively prevent or allow pills to be inserted into the interior cavity or removed from the interior cavity. When the cap is closed, the cap prevents pills from being inserted or removed. When the cap is opened, the cap allows pills to be inserted or removed.

The cap 106 is affixed to the tubular body 102 by a spring hinge 402. The spring hinge 402 is aligned parallel to a longitudinal axis 118 (FIG. 1) of the tubular body 102. The spring hinge 402 allows the cap 106 to spin around an axis 404 defined by the center of the spring hinge 402, exposing the interior cavity 412of the tubular body 102. The motion of the cap 106 is defined by an arc 406. The cap 106 can spin clockwise or counterclockwise. The spring hinge 402 biases the cap 106 to a position enclosing the open end 108 of the tubular body 102. Force must be applied to the cap 106 to place the cap 106 into a different position other than the position enclosing the open end 108 of the tubular body 102. The cap 106 shown is hexagonal to match the hexagonal shape of the tubular body 102. However, the cap 106 could have other shapes. For example, if the tubular body 102 were circular in shape, the cap 106 could also be circular in shape. The cap 106 also need not match the shape of the tubular body 102.

Other types of caps could be used with the pill container 100. The cap 106 need not be attached to the tubular body 102 by a hinge. In some examples, the cap 106 could be a twist-off cap which engages with grooves on the tubular body 102 to cover the open end 108. In some examples, the twist-off cap has “child-resistant” features, similar to the caps used in other pill bottles. In some examples, the cap 106 could be made of rubber or another material that can frictionally engage with the tubular body 102 to resist forces that would otherwise dislodge the cap 106.

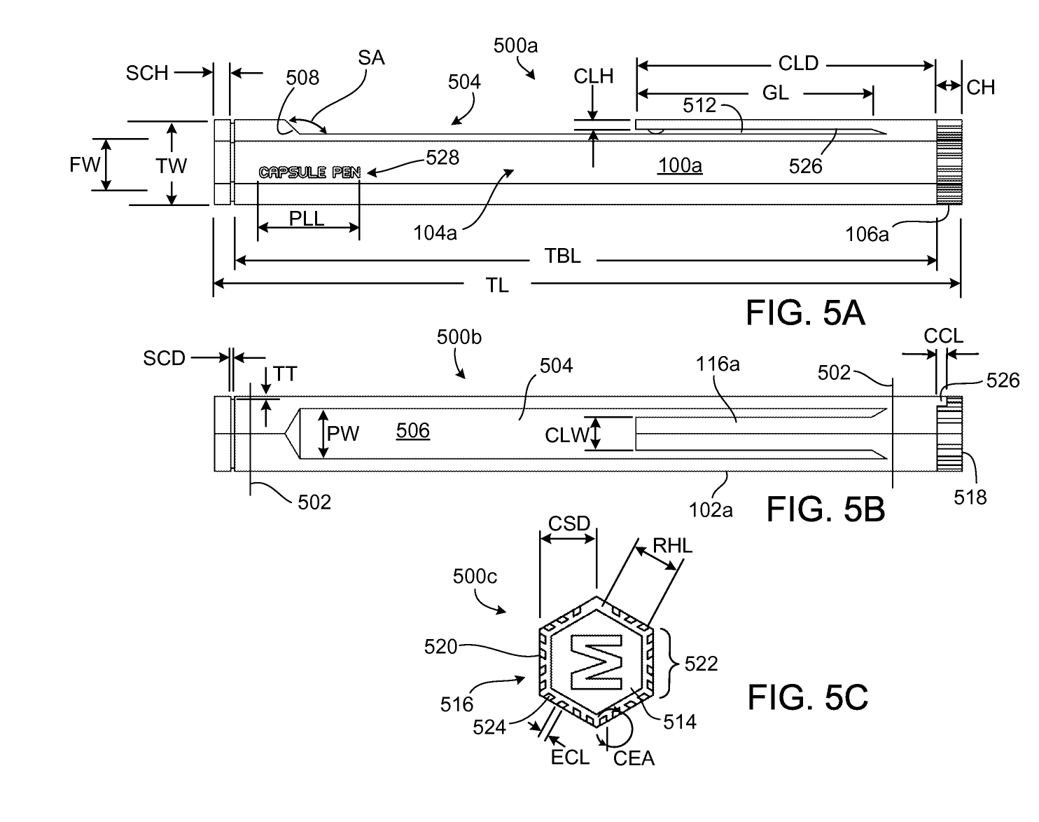

FIGS. 5A, 5B, and 5C show side, top, and front views 500a, 500b, 500c of the one version of pill container 100a and measurements of its components. The pill container 100a shown is one example of the pill container 100 and the measurements described here are examples of measurements that could characterize the physical dimensions of a pill container. None of these measurements are required for a pill container to function and other versions of a pill container could have other measurements.

The total length TL of the pill container 100a is 149 millimeters and is the longest dimension of the pill container 100a. The width TW of the pill container 100a is 17.321 millimeters. In this example, the ratio of length to width of the pill container 100a is 8.6, but other pill containers could have another ratio of length to width such as 5 or a different ratio. The tubular body 102a has a length TBL of 140 millimeters. The cap 106a has a height CH of 5 millimeters. The second cap 112a has a height SCH of 3.2 millimeters. A distance SCD of 0.8 millimeters separates the second cap 112a from the widest portion of the tubular body 102a, such that a narrower portion of the tubular body 102a spans the distance SCD.

The tubular body 102a has a hexagonal cross-section 502. Each face of the six faces of the tubular body 102a has a width FW of 8.66 millimeters. The tubular body 102a has a thickness TT of 0.6 millimeters, such that the interior cavity 104a of the tubular body 102a is enclosed by a material 0.6 millimeters thick. The tubular body 102a has an indentation 504 that interrupts the hexagonal shape of the tubular body 102a. The indentation 504 has a planar surface 506 that extends along a portion of the length of the tubular body 102a. The planar surface 506 has a width PW of 10.046 millimeters. The indentation 504 begins at a distance ID of 10 millimeters from the second open end 114a of the tubular body 102a. A slope 508 defines a first edge of the indentation 504. The slope 508 has an angle SA of 135.97 degrees as measured from the planar surface 506 of the indentation 504.

The clip 116a extends along a portion of the length of the tubular body 102a and terminates at a distance CLD of 60 millimeters from the open end 108a of the tubular body 102a. The clip 116a has a height CLH of 1.91 millimeters and the clip 116a has a width CLW of 6.617 millimeters. The clip 116a defines a gap 512 between the clip 116a and a planar surface 506 of the indentation 504 of the tubular body 102a and the gap 512 has a length GL of 47 millimeters. The interior surface 526 on the bottom of the clip 116a is defines a plane that is parallel to the planar surface 506 of the indentation 504 of the tubular body 102a. The indentation 504 of the tubular body 102a forms the clip 116a, such that the clip 116a is flush with sides of the tubular body 102a. Put another way, the clip 116a conforms to the polygonal shape of the tubular body 102a and does not project beyond the main shape of the tubular body 102a. If the tubular body 102a were another shape, for example, a cylindrical shape (e.g., having a circular or oval cross-section), then the clip 116a could conform to the cylindrical shape. During manufacturing, the clip 116a could be formed by cutting a portion of the tubular body 102a.

The cap 106a has a recessed hexagonal indentation 514 that defines a raised ridge 516 at the edges of the top surface 518 of the cap 106a. Each edge of the recessed hexagonal indentation 514 has a length RHL of 6.928 millimeters. The cap 106a has a shortest diameter CSD of 7.5 millimeters, such that the shortest diameter CSD is a length from the center of the top surface 518 of the cap to a midpoint 520 of any edge 522 of the cap 106a. The angle CEA between any edge 522 of the cap 106a and an adjacent edge is 120 degrees. Each edge 522 of the cap 106a has cutouts each of which span a length ECL of one millimeter. A portion of the cap 106a has a cutout 524 at a location at which the cap 106a is joined to the tubular body 102 by a hinge. The cutout has a length CCL of two millimeters.

This version of the pill container 100a has a product logo 528 on one side of the tubular body 102a. The product logo 528 spans a length PLL of 20 millimeters.

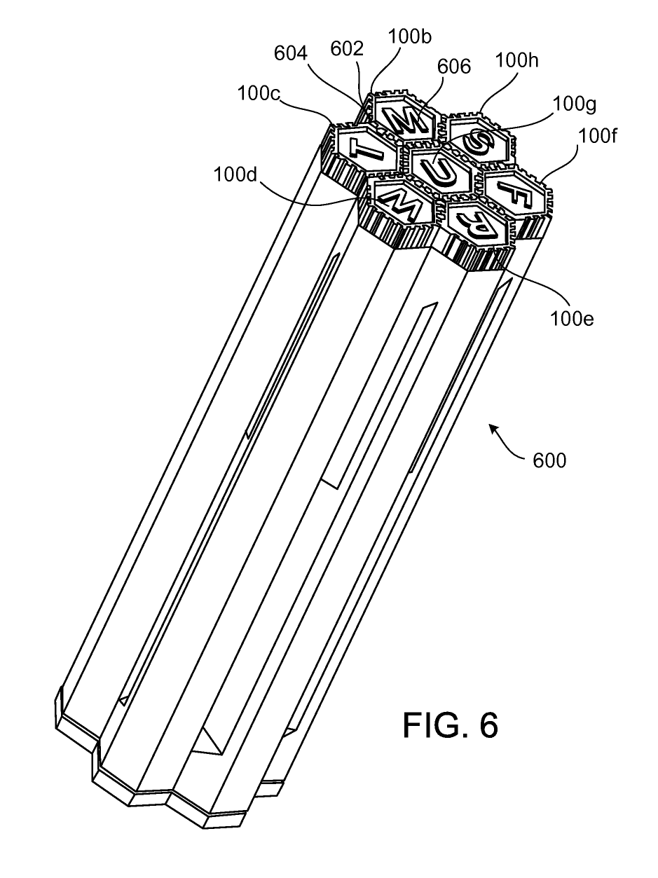

As shown in FIG. 6, a bundle can be formed from a configuration of multiple pill containers. For example, seven hexagonal pill containers 100b-h can be grouped together into a bundle 600. Because the pill containers 100b-h each have a hexagonal shape, the pill containers 100b-h can be arranged such that an edge 602 of one pill container 100b touches an edge 604 of another pill container 100c. If this is done for six of the pill containers 100b-g, then the bundle 600 will form a hexagonal shape. A seventh pill container 100h can be placed in the center of the bundle 600. The bundle 600 can be stored and transported in a manner that conserves space and ensures that the pill containers 100b-h stay together. Further, a bundle 600 of seven pill containers 100b-h allows the pill containers 100b-h to each correspond to a day of a seven-day week. For example, each pill container 100b-h can be filled with pills to be taken on the corresponding day of the week. In some examples, each pill container 100b-h is labeled with an indicator 606 for the day of the week, for example, a letter such as “M” for Monday.

In some implementations, portions of the pill containers 100b-h are magnetized. For example, the caps 106b-h (or second caps 116b-h or both) can be made of or partially made of a magnetic material, or the tubular bodies of the pill containers 100b-h could be made of or partially made of a magnetic material. If the magnetic poles of the magnetized portions of the pill containers 100b-h are aligned correctly then the bundle 600 will stay together and retain its shape.

In some implementations, the pill containers 100b-h could have a shape other than a hexagonal shape. For example, pill containers 100b-h having a cylindrical shape (e.g., having a circular or oval cross-section) can be placed in a bundle 600 of seven pill containers or another number of pill containers.

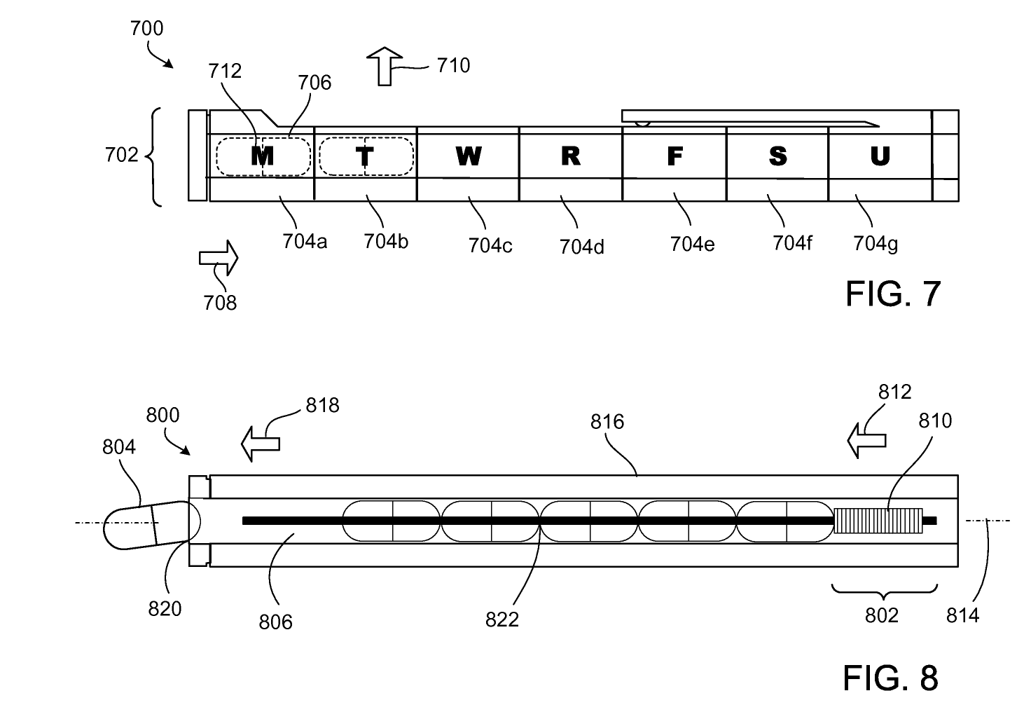

Many different configurations of pill containers are possible. FIG. 7 shows a pill container 700 having a tubular body 702 split into multiple compartments 704a-g. In this example, there are seven compartments 704a-g each sized to fit a single pill. Each compartment 704a has a cover 706 that can be opened and closed to access the compartment 704a within. In some examples, the cover 706 could be partially or completely transparent (e.g., made of a transparent material). In some examples, the cover 706 could be partially or completely opaque (e.g., made of a transparent material). In some examples, the cover 706 could be partially or completely translucent (e.g., made of a translucent material). In some implementations, the cover 706 could be a sliding cover that can be slid 708 to reveal the contents of the compartment 704a. In some implementations, the cover 706 could be a flip cover attached to a hinge, such that the cover 706 can be flipped 710 upward to reveal the contents of the compartment 704a. In some implementations, a cover 706 spans more than two compartments 704a-g, such that the cover 706 can be slid 708 or flipped 710 to reveal the contents of multiple compartments 704a-g.

In some implementations, each compartment 704a can include a buffer material such as a sponge-like material to hold a pill in place and absorb motion of a pill that would otherwise move around within the compartment 704a. In some examples, each compartments 704a-g is labeled with an indicator 712 for the day of the week, for example, a letter such as “M” for Monday.

FIG. 8 shows a pill container 800 having a sliding mechanism 802 that can be used to eject pills 804 from an interior cavity 806. The sliding mechanism 802 has a handle 810 that can be slid 812 along the longitudinal axis 814 of a tubular body 816. A portion of the sliding mechanism 802 which extends into the interior cavity 806 pushes 818 pills 804 along the longitudinal axis 814 and out of an open end 820 of the interior cavity 806. The sliding mechanism 802 travels along the path of a groove 822 cut out of the tubular body 816.

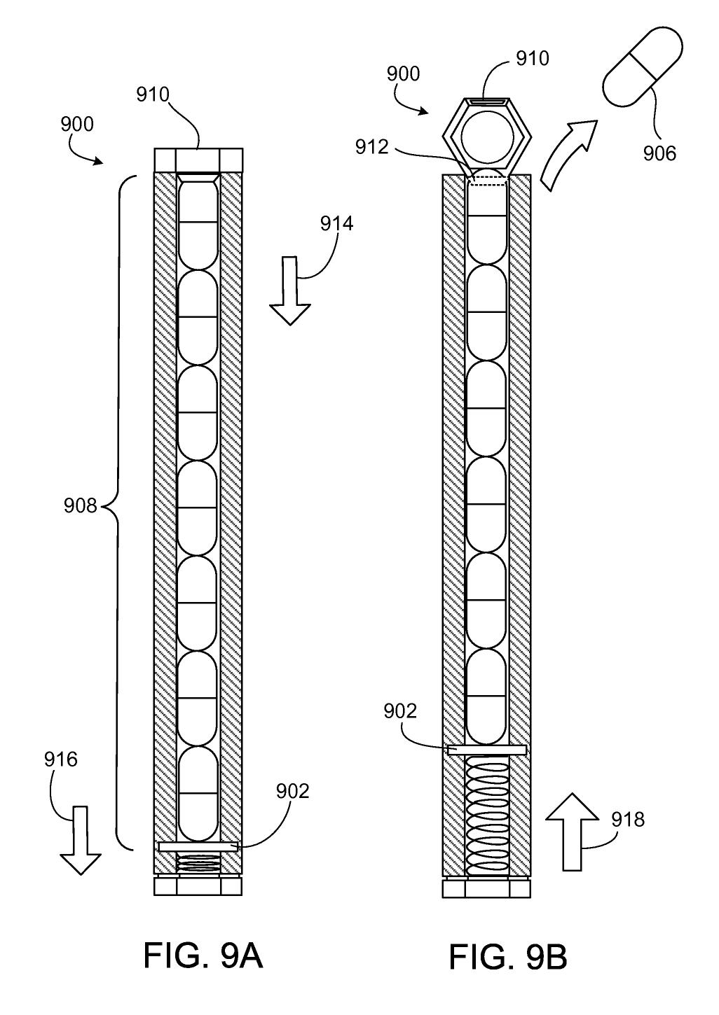

FIGS. 9A and 9B show a pill container 900 having an interior spring 902 that applies pressure 904 on the pills 906 within the interior cavity 908 of the pill container 900. The pressure 904 applied by the interior spring 902 pushes pills 906 out of the interior cavity 908 when a cap 910 is removed from an open end 912 of the interior cavity 908. Pills 906 can be pushed 914 into the interior cavity 908 when the pill container 900 is loaded with pills, thus compressing 916 the interior spring 902. When the cap 910 is opened, the interior spring 902 will push 918 the pills 906 outward so they can be consumed by a user of the pill container 900.

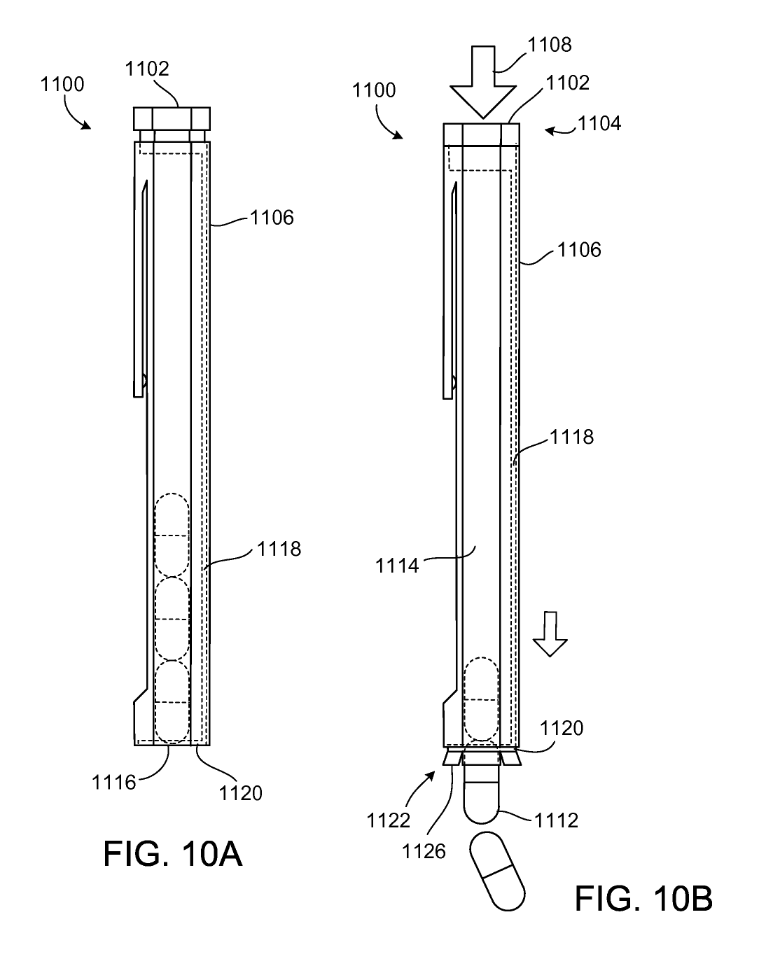

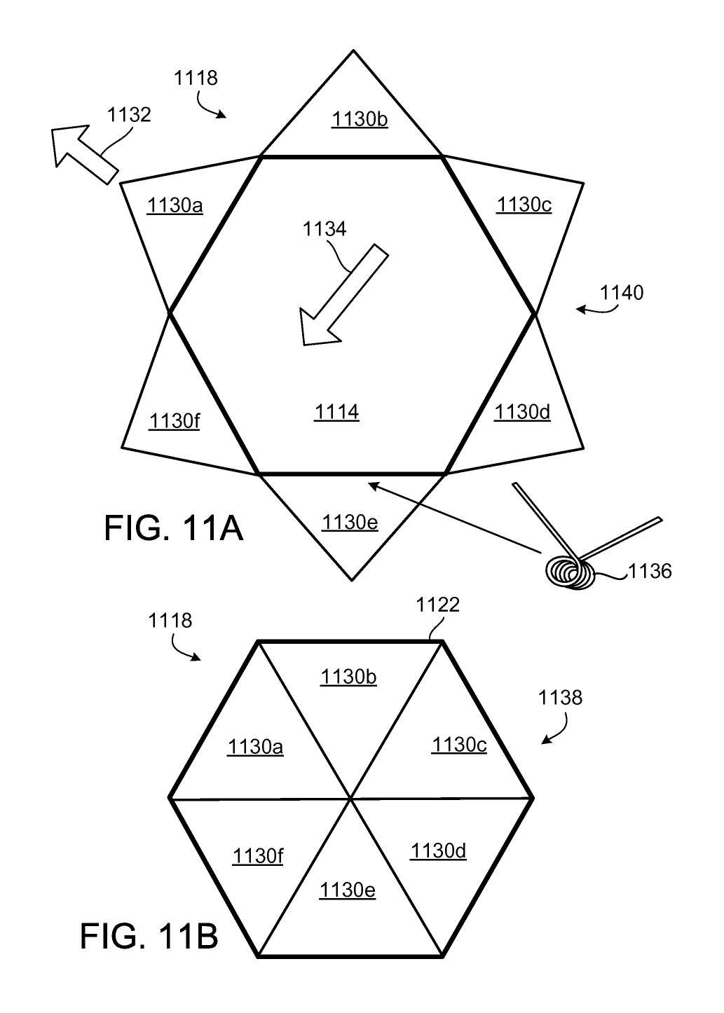

FIGS. 10A and 10B show a pill container 1100 having a button 1102 on one end 1104 of a tubular body 1106. The button 1102 can be pressed 1108 to eject 1110 a pill 1112 from an interior cavity 1114 of the tubular body 1106. The button 1102 is positioned at one end 1104 of the tubular body 1106 and is attached to a rod 1118 within the interior cavity 1114 which is in turn attached to a ring 1120 at a second end 1122 of the tubular body 1106. The ring 1120 is in contact with a sectional door 1116 that covers the second end 1122 of the tubular body. When the button 1102 is pressed 1108 then the pressure causes the rod to apply pressure to the ring 1120, which in turn causes sections 1126 of the sectional door 1116 to open. Pills 1112 can then slide out of the interior cavity 1114.

FIG. 11A and 11B show a close-up view of the sectional door 1116. This sectional door 1116 has six sections 1130a-f, although other numbers of sections can be used in other implementations. Each section 1130a-f flips 1132 open when pressure 1134 is applied to the section. For example, the pressure 1134 can be applied by a ring 1120 manipulated by a button 1102 (FIGS. 10A and 10B). When the sectional door 1116 is open (FIG. 11A) pills can exit the interior cavity 1114, and then the sectional door 1116 is closed (FIG. 11B) the second end 1122 interior cavity 1114 is covered by the sections 1130a-f. In some implementations, some or all of the sections 1130a-f include a spring hinge 1136 that biases the sections 1130a-f to the closed position 1138. When the spring hinge 1136 is used, pressure 1134 must be continuously applied to the sections 1130a-f to keep the sections 1130a-f in the open position 1140.

The sectional door 1116 can be used with other versions of the pill container. For example, the sectional door 1116 could be used with the pill container 800 shown in FIG. 8. In this example, the pills 804 would apply pressure 1134 to the sections 1130a-f to move them to the open position 1140.

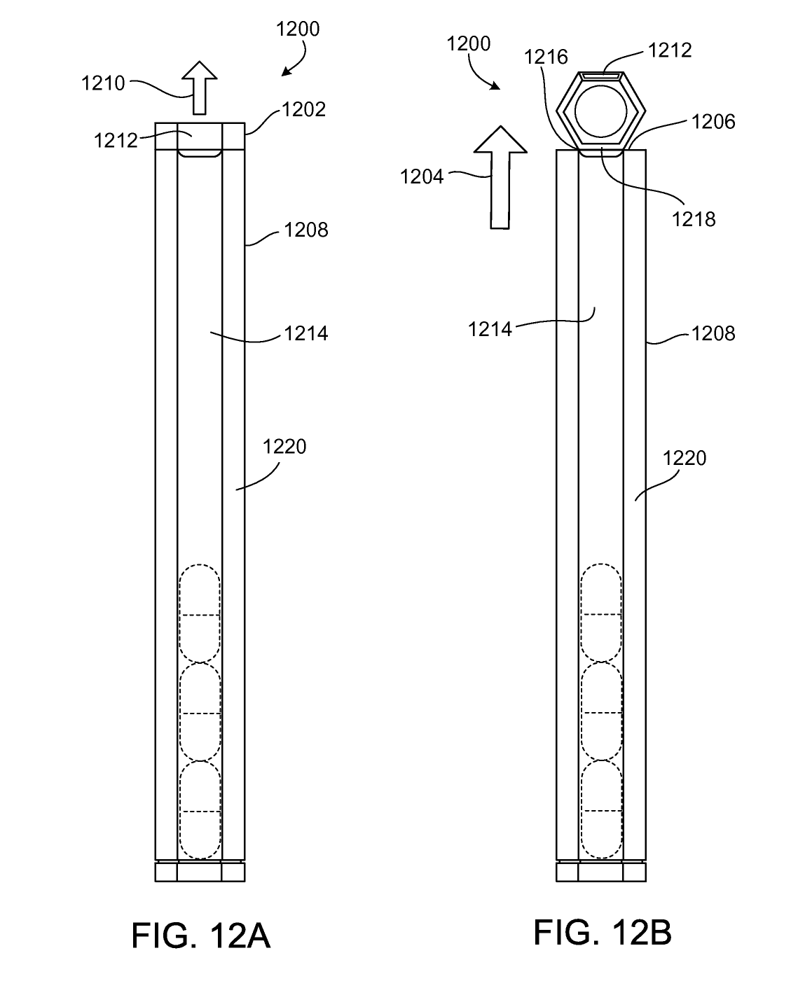

FIGS. 12A and 12B show a pill container 1200 having a cap 1202 that flips 1204 upward. The cap 1202 covers an open end 1206 of a tubular body 1208. When frictional pressure 1210 is applied to an edge 1212 of the cap 1202, the cap 1202 flips 1204 upward. An interior cavity 1214 can then be accessed. The cap 1202 is affixed to the tubular body 1208 by a hinge 1216 that spans the length or a portion of the length of an edge 1218 of the cap 1202. The edge 1218 is opposite the edge 1212 of the cap 1202 to which pressure is applied to open the cap 1202. In some implementations, the shape of the edges 1212, 1218 corresponds to the shape of sides 1220 of the tubular body 1208.

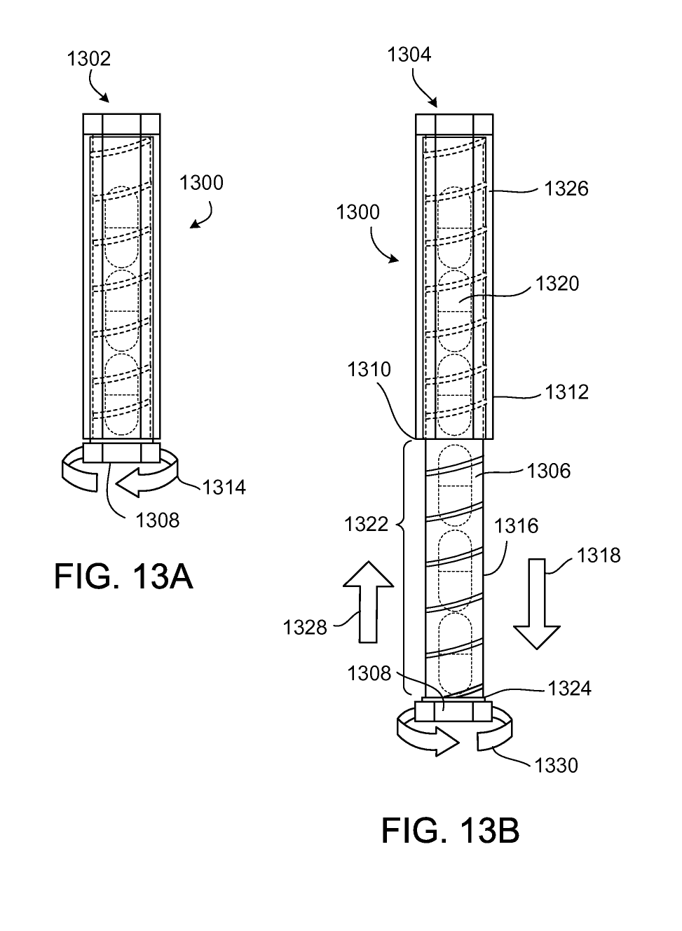

FIGS. 13A and 13B show a pill container 1300 that is expandable and contractible. The pill container 1300 has a contracted configuration 1302 and an expanded configuration 1304. The pill container 1300 can hold a larger number of pills 1306 in the expanded configuration 1304 than the contracted configuration 1302. The pill container has a rotating handle 1308 at one end 1310 of a tubular body 1312. When the rotating handle 1308 is rotated 1314 in one direction (e.g., counterclockwise), a second tubular body 1316 extends 1318 outward from the end 1310 of the tubular body 1312, expanding the space available in an interior cavity 1320. The second tubular body 1316 is sized to fit within the tubular body 1312. The second tubular body 1316 engages with threading 1326 within the tubular body 1312, which provides a guide to the second tubular body 1316 as the rotating handle 1308 is rotated 1314. The second tubular body 1316 can be extended to any point within the distance 1322 between the end of the tubular body 1312 and the maximum extension 1324 of the second tubular body 1316. The second tubular body 1316 can be retracted 1328 by rotating 1330 the rotating handle 1308 in another direction (e.g. clockwise).

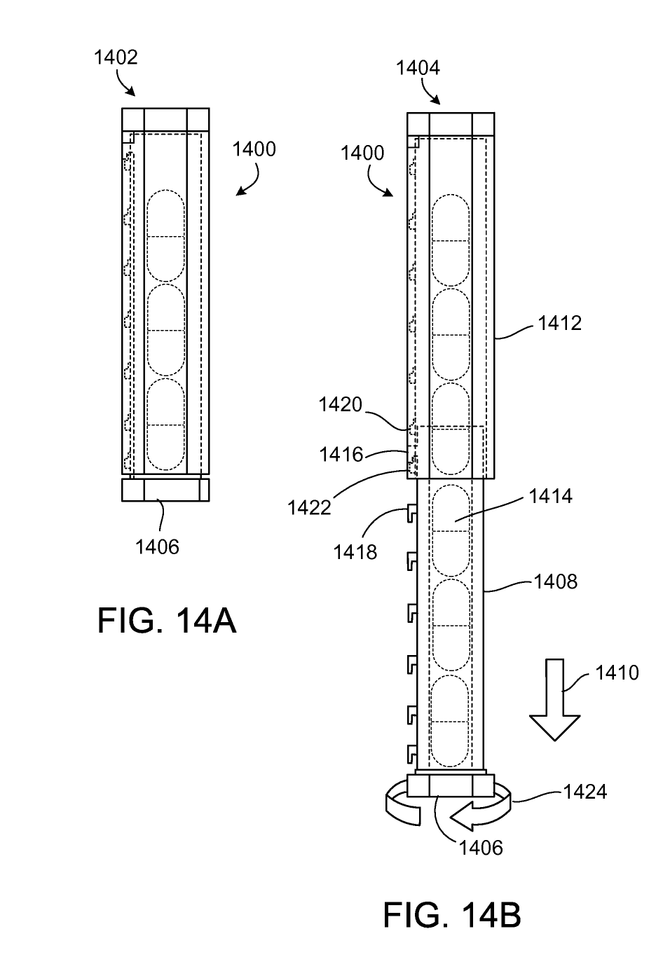

FIGS. 14A and 14B show another pill container 1400 that is expandable and contractible. The pill container 1400 has a contracted configuration 1402 and an expanded configuration 1404. A pull handle 1406 allows a second tubular body 1408 to be pulled 1410 out from a tubular body 1412, expanding the space available in an interior cavity 1414. In some implementations, the second tubular body 1408 has teeth 1416, 1418 which can engage with indentations 1420, 1422 in the wall of the tubular body 1412. The combination of the teeth and indentations acts as a locking mechanism and resists movement of the second tubular body 1408 relative to the tubular body 1412. Further, the combination of the teeth and indentations provides discrete units of expansion of the second tubular body 1408. When the pull handle 1406 is pulled 1410, a tooth 1416 will disengage with one indentation 1420 and engage with the next indentation 1422, expanding the interior cavity 1414 by one unit of expansion. In some implementations, the pull handle 1406 is rotated 1424 (e.g., either clockwise or counter-clockwise) to disengage a tooth 1416 from an indentation 1420, then the pull handle 1406 is pulled 1410, and then the pull handle 1406 is rotated 1424 again to engage the tooth 1416 with the next indentation 1422. Other types of locking mechanisms could be used to resist movement of the second tubular body 1408 relative to the tubular body 1412. For example, a pin or a screw could be used.

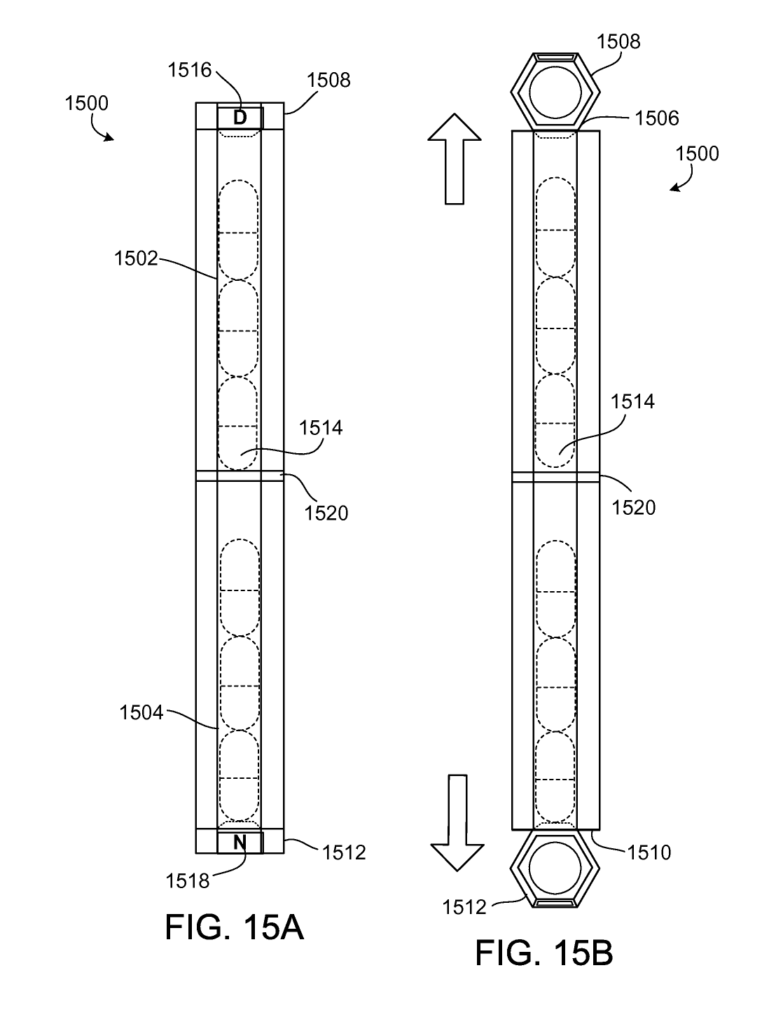

FIGS. 15A and 15B show a pill container 1500 having a first interior cavity 1502 and a second interior cavity 1504. Each interior cavity 1502, 1504 is sized to contain at least one pill. The first interior cavity 1502 is accessible at a first open end 1506 that is covered by a first cap 1508, and the second interior cavity 1504 is accessible at a second open end 1510 that is covered by a second cap 1512. A divider 1520 separates the two cavities. A pill 1514 placed in the first interior cavity 1502 cannot be accessed in the second interior cavity 1504 and vice-versa. Each cavity can be demarcated for a particular purpose. For example, an indicator 1516 placed on the first cap 1508 can indicate that the first interior cavity 1502 contains pills to be taken in the daytime, and an indicator 1518 placed on the second cap 1512 can indicate that the second interior cavity 1504 contains pills to be taken in the nighttime.

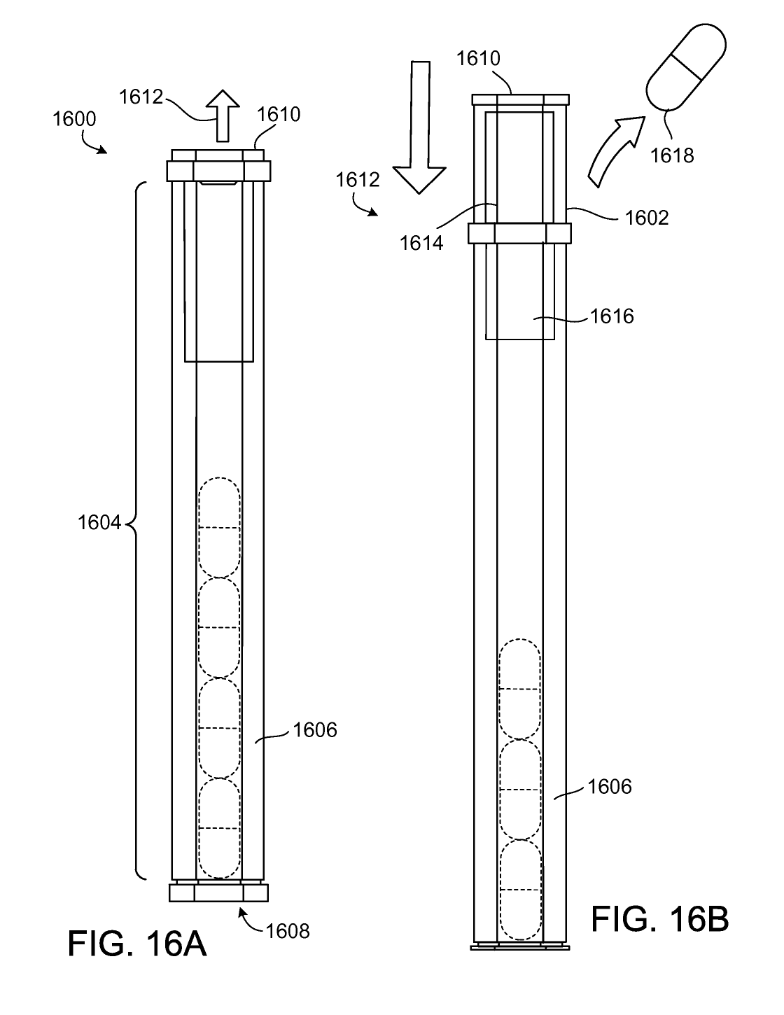

FIGS. 16A and 16B show a pill container 1600 having an inner tubular body 1602 that functions as a drawer. The inner tubular body 1602 and an outer tubular body 1606 of the pill container 1600 have an approximately similar length 1604 to each other. In a closed configuration 1608, the inner tubular body 1602 is contained entirely within the outer tubular body 1606. When a pull handle 1610 of the inner tubular body 1602 is pulled 1612, a portion of the inner tubular body 1602 is exposed. The inner tubular body 1602 has a cutout 1614 that exposes an inner cavity 1616 of the inner tubular body 1602. When the cutout 1614 is exposed, pills 1618 can be inserted into or removed from the inner cavity 1616.

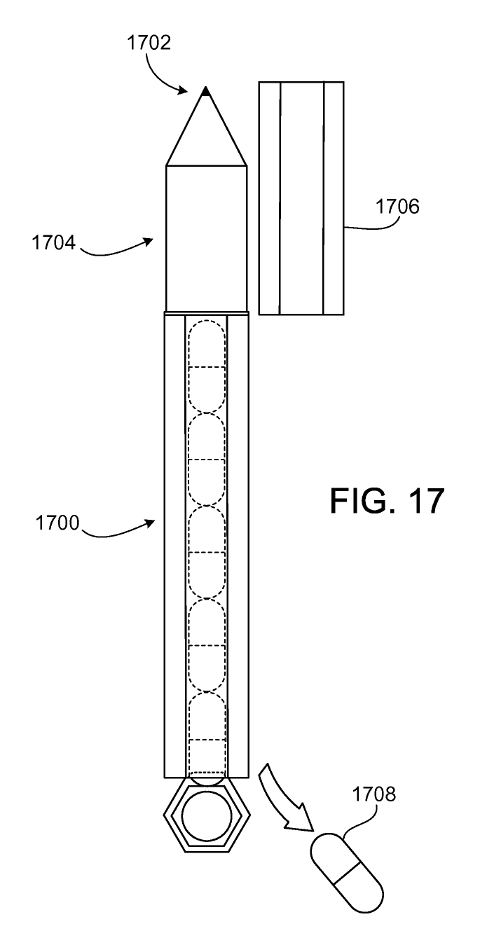

FIG. 17 shows a pill container 1700 that can function as a writing instrument. As noted above, the various versions of the pill container described herein have approximately the same size and dimensions as a writing instrument. This version of the pill container 1700 has a writing tip 1702 that can be used to write on any conventional writing surface such as paper. One end 1704 of the pill container 1700 has a removable cap 1706 that, when removed, exposes the writing tip 1702.

In some implementations, the writing tip 1702 expresses ink and contains an ink tank. For example, the writing tip 1702 may be removable and contain an ink tank that can be refilled or replaced. In some implementations, the writing tip 1702 contains pencil graphite and can be reloaded with graphite pieces. In some implementations, the writing tip 1702 is a stylus tip suitable for use on an electronic device having a touch sensitive surface such as a smartphone or a personal digital assistant or a tablet computer. The pill container 1700 can also contain pills 1708 in a similar manner as the other pill containers described herein.

In some implementations, a clip 116 (FIG. 1) is attached to the removable cap 1706, similar to the manner in which a clip is attached to a cap of an ink pen.

In some implementations, the pill container can be arranged to contain objects other than pills. For example, a pill container 100 (FIG. 1) can be sized to fit a single syringe within an interior cavity, rather than or along with pills. As another example, the pill container 100 can be sized to fit a single headphone device within an interior cavity. For example, the headphone device could be a pair of earbuds and wires attached to the earbuds (e.g. for attaching the earbuds to a music player, smart phone, or other device).

In some implementations, the pill container can contain electronics, for example, components that provide electronic reminders, or communication devices that can interact with electronic devices such as computer systems or mobile devices such as smart phones.

Many other configurations are possible. The implementations described here are only examples and other implementations are within the scope of the claims.

What is claimed is:

1.-30. (canceled)

31. An apparatus for admitting, holding, and providing access to one or more pharmaceutical pills. said apparatus comprising:
at least seven pill containers arranged adjacent one another in a hexagonal configuration. each said pill container comprising:
a generally tubular body elongated along a longitudinal axis. said tubular body having an interior cavity and a first open end; and
a first cap at said first open end for selectively allowing insertion or removal of said pharmaceutical pills into or from said interior cavity;
wherein said interior cavity extends along said longitudinal axis and is sized to receive a plurality of pharmaceutical pills:
wherein said interior cavity has a cross-sectional dimension that is perpendicular to said longitudinal axis and sized to fit a single one of said pharmaceutical pills at a single point along said longitudinal axis within said cavity:
wherein said first open end is sized for admitting or removing said pharmaceutical pills into or from said cavity; and
wherein at least a portion of each said pill container comprises a magnetic portion such that said pill container is operatively magnetically securable to an adjacent other one of said pill containers.

32. The apparatus according to claim 31, wherein said first cap of each said pill container comprises said magnetic portion.

33. The apparatus according to claim 31, wherein said tubular body of each said pill container comprises said magnetic portion distant said cap.

34. The apparatus according to claim 31, wherein a shape of said cross-sectional dimension of said pill containers is selected from the group consisting of circular, oval and polygonal.

35. The apparatus according to claim 31, wherein said first cap is movably affixed to said tubular body by a hinge.

36. The apparatus according to claim 31, wherein said first cap is removably affixed to said tubular body in a press fit configuration.

37. The apparatus according to claim 31, wherein said first cap is removably affixed to said tubular body in a screw-like configuration.

38. The apparatus according to claim 31. wherein said tubular body further comprises a second open end sized for admitting or removing said pharmaceutical pills into or from said pill container.

39. The apparatus according to claim 38. further comprising a second cap positioned at said second open end.

40. The apparatus according to claim 31, wherein said device has a shape corresponding to a shape of said cross-sectional dimension.

41. The apparatus according to claim 31, wherein said tubular body has a length of at least five times greater than a width of said tubular body.

42. The apparatus according to claim 31, wherein said tubular body includes a clip for affixing said pill container to an item.

43. The apparatus according to claim 31. wherein at least a portion of said tubular body is substantially opaque.

44. The apparatus according to claim 31. wherein at least a portion of said tubular body is substantially translucent.

45. The apparatus according to claim 31, wherein at least a portion of said tubular body is substantially transparent.

46. The apparatus according to claim 31, wherein said tubular body is made from a material selected from the group consisting of metal, plastic, wood. glass, fiberglass, stone, rubber., clay, porcelain. bamboo, paper, cardboard, natural material. synthetic material, recycled material and disposable material.

47. An apparatus for admitting, holding, and providing access to one or more pharmaceutical pills, said apparatus comprising:
at least seven pill containers. each said pill container for holding a plurality of elongated pharmaceutical pills arranged in a row within an oblong chamber of said pill container;
wherein said pill containers are configured so as to be arranged adjacent one another in a hexagonal configuration,
wherein a cross-sectional dimension of said chamber is smaller than an elongated dimension of any one of said elongated pharmaceutical pills. and
wherein at least a portion of each said pill container comprises a magnetic portion such that said pill container may be magnetically secured to another one of said pill containers.

48. The apparatus according to claim 47, wherein a shape of said cross-sectional dimension of said container is selected from the group consisting of circular, oval and polygonal.

49. The apparatus according to claim 47, wherein said pill container further comprises:
a cap to selectively allow insertion or removal of said pharmaceutical pills into or from said interior cavity.

50. The apparatus according to claim 49, wherein said cap of each said pill container comprises said magnetic portion.
